(19) United States
(12) Patent Application Publication
(10) Pub. No.: US 2011/0057346 A1
(43) Pub. Date: Mar. 10, 2011

(54) ART OF USING REGENERATED FIBERS IN MULTI PROCESS NON-WOVENS

(76) Inventor: Kayren J. Nunn, Bixby, OK (US)

(21) Appl. No.: 12/605,342

(22) Filed: Oct. 25, 2009

Related U.S. Application Data
(60) Provisional application No. 61/240,884, filed on Sep. 9, 2009.

(51) Int. Cl. B29C 59/02; D04H 1/64; D04H 3/12; D21B 1/04; D04H 1/46

(52) U.S. Cl. 264/103; 264/128; 264/119; 264/112; 264/115; 28/103

(57) ABSTRACT

Processes for producing non-woven materials from regenerated cotton and other fibers are disclosed. In one embodiment, the processes involve first regenerating cotton fibers from post-consumer or post-industrial waste. These regenerated fibers can be blended with other fibers, and intimately blended to provide a uniform blend of fibers. The fibers can then be subjected to a carding process to orient the fibers, and bound together using mechanical, chemical, or thermal binding processes to form a non-woven material. This material can then be used to form finished goods.

### FIELD OF THE INVENTION

The present invention is generally in the field of non-woven materials, and processes for their manufacture. More particularly, the invention is in the field of non-woven materials produced from regenerated fibers, where the regenerated fibers are obtained, at least in part, from post-consumer or post-industrial waste.

### BACKGROUND OF THE INVENTION

Roughly a hundred billion pounds of post-industrial waste are landfilled or incinerated each year. While there are processes for recycling or regenerating these materials, such process traditionally provide materials used in lower value products such as carpet padding, automotive acoustic panels, and other items not visually impacted by a “shoddy fiber” technology. While these are good uses for pre or post industrial waste streams, consumers want more sustainable products in their everyday lives. The area of non-wovens, such as personal care products and household wipes, is a rapidly growing industry. There would be a tremendous value associated with using fibers which have been repurposed through a regeneration process into such non-woven products, instead of using virgin materials. This is particularly true for disposable products. Fibers that have been re-purposed using fiber regeneration technology could potentially offer a better product, at a cost advantage, resulting in an overall sustainable product that is good for the planet, consumers, and producers alike.

It would be advantageous to provide new processes for regenerating and reusing the fibers present in post-consumer and/or post-industrial waste. The present invention provides such processes, as well as products prepared using the processes.

### SUMMARY OF THE INVENTION

A process for upcycling and transforming waste materials into value added consumer products is disclosed. The process adds characteristics of the material that could not be otherwise afforded using traditional virgin components, and which are aesthetically pleasing and offer value to a quality consumer product.

The process uses traditional non-woven equipment, but makes specialized and unique changes to create environmentally-sustaining products. In one embodiment, the process provides non-woven products that would otherwise cost significantly more to produce if the products were made using virgin materials.

The process can use post-industrial or post-consumer waste streams as feedstocks. The waste streams include fiber-containing materials, and the fibers can be isolated from the waste streams and regenerated in order to achieve maximum benefit from the fiber lengths, strengths, and other properties. The fibers can be efficiently processed through a traditional or modified non-woven process into a finished roll good. The finished roll good can then be converted into a variety of consumer products.

In one embodiment, the regeneration process for using recycled fibers opened to soft thread form in crosslapped non-wovens is disclosed in U.S. Pat. No. 6,378,179.

The process described herein takes us several steps forward relative to other processes, in that it eliminates soft threads and individualizes the fibers, and due to this new process, it can be used to upcycle and transform the hundreds of millions of pounds of waste that would have otherwise found its way to a landfill or incinerator.

The process creates products that are superior in certain qualities and characteristics to those made from virgin materials, typically at less cost, or in a cost competitive manner relative to processes using virgin materials. Thus, the process can reduce the carbon footprint associated with producing the products, reduce water usage, and reduce the use of chemicals by greater than 90% relative to processes using virgin materials, thus creating a true sustainable product and process.

Representative post industrial or post consumer waste streams that can be used as feedstocks include fabrics such as knits, for example, t-shirts, socks, undergarments; wovens, from items such as shirting, sheeting, bottom weight, denim, bedding, and upholstery; and non-wovens. These materials can be bleached white, or optically brightened or dyed fabrics, and can be used to increase value and reduce cost by using the materials as they are to create a higher valued product without using additional bleaches or dye baths to achieve the same results. For example, a baby wipe can be made with regenerated cotton from knits and wovens, where the cotton is already white, so no bleaching or optical brighteners are necessary to add to this process. At the same time, creating a non-woven out of a colored fiber waste stream, such as denim, can result in a pale blue wiping cloth perfect for industrial or household non-wovens, without the need for additional dyes or colorants, to create a value added product for the consumer product arena.

These materials typically include fibers that are either 100% cotton, or blends of cotton and various other fibers, such as polyester, viscose, rayon, polyolefins, and the like.

The process can also incorporate other fibers, including natural and synthetic fibers, such as fibers from seeds, stalks, basts, stems, leaves, or fruits, fibers derived from animal hair, and silk fibers or other protein based fibers. The other fibers can be transformed natural fibers (i.e., cellulose derivatives), and wholly-synthetic fibers. The other fibers can also include inorganic fibers, such as glass fibers and metal fibers.

At least a portion of the fibers are isolated from post-industrial or post-consumer waste. To isolate fibers from these materials, which are previously woven, knitted, or bonded together by a non-wovens process, it is necessary to un-weave or un-twist the threads. This can be accomplished, for example, by removing post-treatments from the threads, which thins the threads and loosens the knots or twists. In the case of cellulosic fibers, a portion of the cellulosic fiber can be degraded, for example, using a cellulose enzyme. Once the threads are unwoven/untwisted, the fibers are obtained by combing the thread, which produces fibers that have maintained the length and the strength necessary to go back to textiles or, in this embodiment, non-wovens.

Before going into textiles or non-wovens, it can be advantageous to pass the fibers through one or more stages of “intimate blending,” so that the fiber distribution is relatively homogeneous. The term “relatively homogeneous” is used to mean that the average fiber size and density varies by 20% or less throughout the fiber. The intimate blending can also provide color uniformity, which can otherwise be difficult to attain when different batches of fibers are used to produce a single non-woven fabric.

Intimate blending involves initially humidifying or treating the fibers, which strengthens the fibers, if they are organic fibers such as cotton, cotton blends or fibers such as rayon or ramie, reduces dust particles for better product performance and, protecting the fibers from tensile elongation, and reduces neps. The fibers can be humidified, for example, by exposing them to steam, contacting them with a hydrophilic compound such as glycerol/glycerine, a surfactant, water, and the like. Ideally, the humidified fibers have a moisture content of between 8 and 20% moisture, more ideally, between about 8 and about 12% moisture. Then, the fibers can be passed through one or more blending stages, where samples from multiple hoppers are blended together to reduce variation between the fibers in the hoppers, or where samples from a single hopper are blended to ensure consistency in the hopper or it could be blended using a traditional cotton/fiber laydown where bales are staged for blending. Multiple hoppers can be used, for example, where blends of different fibers are intended. Examples include using regenerated cotton fibers in combination with one or more virgin or regenerated plant fibers, such as wood, kenaf, and the like, or synthetic fibers, such as polyester or polyolefin fibers. However, the regenerated cotton fibers can be used by themselves, without adding other fibers.

The fibers at this stage in the process are randomly oriented, but can be oriented using a non-woven or textile carding process.

In the process described herein, a fabric is made directly from a web of the intimately blended fiber, without the yarn preparation necessary for weaving and knitting. In a non-woven process, the assembly of textile fibers can be held together 1) by mechanical interlocking in a random web or mat; 2) by fusing the fibers, as in the case of thermoplastic fibers; or 3) by bonding the fibers with a cementing medium, such as starch, casein, rubber, latex, a cellulose derivative, or a synthetic resin.

Initially, the fibers may be oriented in one direction or may be deposited in a random manner. The web or sheet is then bonded together, using one of the methods described above. In the process described herein, suitable fibers have lengths ranging from 250 microns to 6 inches. The fibers can be straight, or, for more strength, can be crimped.

The web or sheet is converted to a non-woven fabric, which can then be rolled up for storage until it is ready to be converted to a finished product. Before being rolled up, it can be subjected to one or more post-treatments, such as dyeing, embossing, dye removal, antimicrobial treatments, fire retardant treatments, anti-stain treatments, and taggants. Taggants, for example, can involve tagging the fabric with a chemical or physical marker so that the consumer can verify that they are purchasing a product that includes regenerated materials.

Representative post-treatments include humidification, the addition of surfactants to provide more hydrophilic products, such as wipes or other substrates used in aqueous solutions, or a substrate needing to be used to absorb liquids. Other such treatments include treatment with starch, glycol/glycerin, antimicrobial agents, such as cationic polymers/cationic latex, silicones, fluorinated agents which provide the material with anti-stain protection, and the like. These treatments can occur after the fabric has been formed, or before the fibers are mechanically/thermally/chemically bonded.

In one embodiment, the randomly-oriented, intimately blended fibers are subjected to a carding process to form a uniform fiber web. The uniform fiber web is passed, over a conveyor belt or a web, where it can optionally be combined with one or more layers of fibers or webs of fibers.

In one embodiment, the one or more layers of fibers comprise different fibers than the first layer of fibers. The additional one or more layers can comprise randomly-oriented fibers, for example, laid down in an air-laid process over the top of the oriented fiber web, and, optionally, a further oriented fiber web can be laid on top of the randomly-oriented fibers. In this embodiment, the outer appearance of the resulting non-woven material is aesthetically appealing, as it is smooth and without unaligned fibers. However, the inner layer of randomly-oriented fibers provides the material with improved strength, relative to oriented fibers.

In another embodiment, a scrim layer is added to the substrate to provide the non-woven material with added strength, which can be important for such uses as re-useable non wovens.

In another embodiment, a plurality of layers is overlapped so as to form a cross-lapped material. In this embodiment, the plurality of layers adds another dimension of strength, and, in some cases, a loftier product.

In a further embodiment, a composite material is formed by adhering the non-woven layer to one or more of a scrim, a additional fiber layers, polymer layers, and the like. This allows regenerated fibers that have unique characteristics to be added to the substrate, including the ability to carry, for example encapsulated oils, lotions, or antimicrobial properties.

In another embodiment, the randomly-oriented, intimately mixed fibers are laid out, using an air-lay process, and bonded together using chemical, mechanical, or thermal techniques.

In some embodiments, a combination of regenerated fibers and polyolefin or other thermoplastic fibers is used, so that the fibers can be bonded in a thermal fashion rather than a chemical or mechanical fashion. In this embodiment, the thermoplastic fibers are typically present in a concentration of at least around 5% w/w.

In another embodiment, the fibers are subjected to a wet-lay process.

In any of these embodiments, a cationic wet-strength resin can be applied, via dipping, spraying, and the like, to impart additional strength to the material after the resin is cured.

The rolled material can then be un-rolled, cut to an appropriate size, and used to prepare one or more finished goods.

Examples of some of the potential non-woven fabric production methods include, but are not limited to, hygiene products, medical products, filters, geotextiles, and other products, and specifically include wipes. The wipes can be adapted to include a variety of additional components, including moisturizers, cleansers, essential oils, antibacterials, antivirals, antimicrobial cationic polymers, and the like.

### BRIEF DESCRIPTION OF THE FIGURES

FIG. 1 is a schematic illustration of a carding apparatus.

### DETAILED DESCRIPTION

The regeneration process, the non-woven material produced using the process, and finished goods prepared from the non-woven material, are described in detail below. The process described herein generally involves recovering fibers from post-industrial or post-consumer waste, optionally blending those fibers with other fibers, optionally subjecting the fibers to an “intimate blending” step to provide a uniform blend of fibers. The fibers can then be subjected to a carding process to orient the fibers, laid out in a random pattern, or combinations thereof, to form a web or mat. The fibers in the web or mat can then be bonded to form a non-woven material using a chemical binding process, a thermal binding process, and/or a mechanical binding process. Each of these steps is described in more detail below.

The present invention will be better understood with reference to the following definitions:

### DEFINITIONS

As described in more detail herein, fibers are formed into a web using a variety of processes, which include techniques for a) orienting or not orienting the fibers, b) laying the fibers down to form a web, and c) bonding the fibers in the web to form a non-woven material. Carding processes are typically used to orient the fibers. The fibers can be laid down on a moving conveyor belt using a variety of techniques, including direct carding lay, air carding, air lay, wet lay, and the like. The laid-down fibers can then be bonded using one or more of mechanical, chemical, or thermal bonding techniques. Terms of art in connection with the laying down of fibers, and the bonding of the laid-down fibers, are defined below.

Non-Woven Fabric

As used herein, a “non-woven fabric” is defined as a fabric made directly from a web of fiber, without the yarn preparation necessary for weaving and knitting. In a non-woven, the assembly of textile fibers is held together 1) by mechanical interlocking in a random web or mat; 2) by fusing of the fibers, as in the case of thermoplastic fibers; or 3) by bonding with a cementing medium such as starch, casein, rubber latex, a cellulose derivative or synthetic resin. Initially, the fibers may be oriented in one direction or may be deposited in a random manner. This web or sheet is then bonded together using a variety of methods, which are described in detail below.

Various techniques can be used to prepare the initial assembly of textile fibers, including air carding, direct lay carding, air lay, and wet lay.

Carding

As used herein, “carding” is a mechanical process that breaks up locks and unorganized clumps of fiber, and then aligns the individual fibers so that they are more or less parallel with each other. These ordered fibers can then be passed on to other processes that are specific to the desired end use of the fiber. Carding can also be used to create blends of different fibers or different colors. When blending, the carding process combines the different fibers into a substantially homogeneous mix. Commercial cards commonly have rollers, and may optionally have systems in place to remove various contaminants from the fibers.

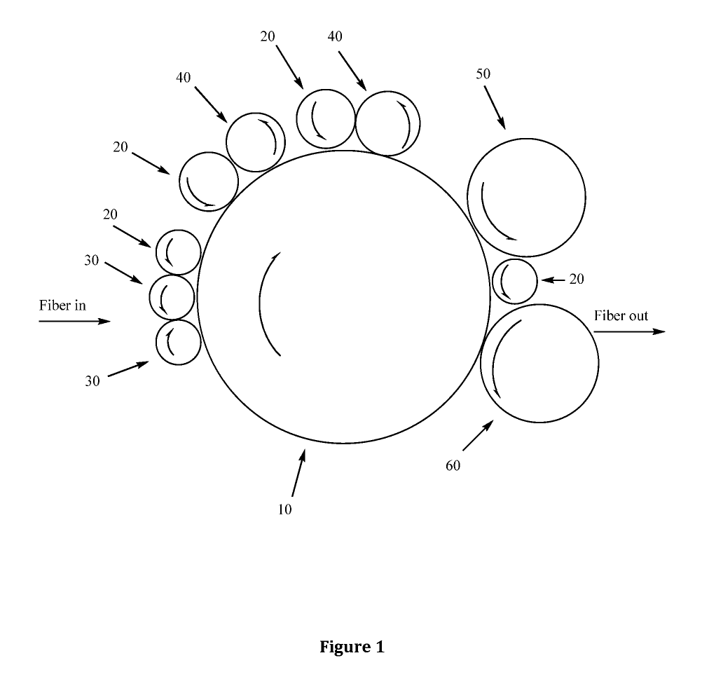

Commercial carding machines allow the “carded” fiber to pass through the workings of the carder for storage or for additional processing by other machines. A typical carder has a single large drum (called the “swift”) accompanied by a pair of in-feed rollers (“nippers”), one or more pairs of worker and stripper rollers, a “fancy,” and a “doffer.” In-feed to the carder is usually accomplished by conveyor belt, and often the output of the carder can either be stored as a batt, or further processed into the non-woven material described herein by mechanically, chemically, or thermally bonding the fibers together. A representative carder is shown in FIG. 1. in FIG. 1, raw fiber, placed on an in-feed table or conveyor, is moved to the nippers (30) which restrain and meter the fiber onto the swift (10). As they are transferred to the swift, many of the fibers are straightened and laid into the swift's card cloth. These fibers will be carried past the workers (40)/stripper rollers (20) to the “fancy” (50).

As swift (10) carries the fibers forward from the nippers (30), those fibers that are not yet straightened are picked up by a worker (40) and carried over the top to its paired stripper (20). Relative to the surface speed of the swift (10), the worker (40) turns quite slowly. This has the effect of reversing the fiber. The stripper (20), which turns at a higher speed than the worker (40), pulls fibers from the worker (40) and passes them to the swift (10). The stripper's relative surface speed is slower than the swift's, so the swift (10) pulls the fibers from the stripper (20) for additional straightening.

Straightened fibers are carried by the swift (10) to the fancy (50). The fancy's card cloth is designed to engage with the swift's card cloth so that the fibers are lifted to the tips of the swift's card cloth and carried by the swift (10) to the doffer (60). The fancy (50) and the swift (10) are the only rollers in the carding process that actually touch.

The slowly turning doffer (60) removes the fibers from the swift (10) and carries them to a fly comb (not shown) where they are stripped from the doffer. A fine web of more or less parallel fiber, a few fibers thick and as wide as the carder's rollers, exits the carder at the fly comb by gravity or other mechanical means. The web can then be stored, or further processes into a non-woven material using the additional process steps described herein.

A carder typically includes a “card cloth.” A card cloth is made from a sturdy rubber backing, in which closely-spaced wire pins are embedded. The shape, length, diameter, and spacing of these wire pins is dictated by the card designer and the particular requirements of the application where the card cloth will be used.

Card Room

The carding step is typically conducted in a room, called a “card room,” which is set up to handle the carding equipment, and also to provide the appropriate temperature and pressure for the fibers, in order to maintain their length and strength throughout the carding process.

Moisture Requirements:

In order to maintain the length and strength of the fibers, it is preferred to control the moisture content of the fibers as they are carried out through the various process steps. Ambient temperature (i.e., around 75° F.) is ideal, and a relative humidity of around 65% is also ideal, although these can vary, according to each individual non-woven product being created, and the ranges of regenerated fibers in each product.

In one embodiment, the product includes relatively high percentages of regenerated cotton fibers, and therefore requires relatively higher humidity. The ranges of temperature and humidity are ideally within the following parameters: temperature between 62 and 98° F. and relative humidity between 40 and 90 percent.

Filtration Points in Non-Woven Web-Forming Equipment

Due to the short staple that is inherent in regenerated fibers, there may be dust particles that accompany the fiber throughout the regeneration process. In order to efficiently use regenerated fibers, it can be desirable to remove the dust particles. One way to do this is to modify traditional equipment running synthetic fibers, so that the dust particles are removed, and the regenerated cotton fiber can be run at around the same efficiencies as that of synthetics. If the dust particles are not removed, the dusting can cause problems with equipment, such as shut downs or overheating.

One such modification involves placing “suction points” throughout the carding equipment to insure cleanliness of motors, drives, web formation, and the like. These “suction points” can remove the dust, and eliminate or minimize the problems associated with dust particles.

Card Wire Specification: If a non-woven card is used in the process of web formation it is very important that the proper metallic toothwire is used that is specific to the raw material requirements. In this embodiment we are specifically talking about the success of manufacturing a non-woven product with high percentages of regenerated cotton, therefore a critical element of the success of this process is the proper metallic toothwire made specific to cotton. For example, while there are many producers of wire specific to cotton, JD Hollingsworth is a manufacturer of card clothing that has a number of patents around the appropriate wire for cotton. While they focused their research on virgin cotton, the points on the wire is similar since the regeneration of the fiber returns the cotton back to its original lengths and strengths. Examples . . . . The points are critical and the following would be the preference in the manufacturing of a high regenerated cotton product as this embodiment describes. It is not always necessary to use a card clothing/wire specific to cotton, but it is the preferred manufacturing option. There are other wires specific to synthetics and have a much broader range of options.

### I. Origin of Regenerated Fibers

In one embodiment, the regenerated fibers are recovered and regenerated from fabrics such as knits, including t-shirts, socks, and undergarments; wovens, including items such as shirting, sheeting, bottom weight, denim, bedding, and upholstery; and non-wovens.

These fibers typically include one or more of the following: 100% cotton, cotton blends, such as cotton/polyester, cotton/viscose, cotton/lycra, cotton/ramie, cotton/nylon, and the like, viscose/rayon, polyester, polypropylene or other polyolefins, nylon or other polyamides, and ramie.

II. Additional Fibers that can be Added

In addition to the fibers described above, other fibers can also be used. Representative other fibers include natural, organic, and synthetic fibers.

Natural fibers include those from various plants/vegetables. Examples of fibers derived from seeds include cotton and kapok (KP).

Examples of fibers derived from basts or stems include wood, flax, linen (LI), hemp (HA), sunn hemp (SN), jute (JU), ramie (RA), kenaf (KE), straw (STR), banana (BAN), pineapple (PIN), papyrus (PAPY), alfagras/esparto (AL), fique/Mauritius Fiber (FI), alginate (ALG), urena/Congo Jute (JR)), nettle (NTL), broom (GI), apocynum (APO), raffia (RAF), and natural bamboo (BAM).

Examples of fibers derived from leaves include sisal (SI), abaca/Manila (AB), henequen (HE), phormium/New Zealand Fiber (NF), acacia (AKAZ), aloe (ALO), yucca (YUCC), and elephant grass (ELEG).

Examples of fibers derived from fruit include coir/coconut (CC).

Animal fibers include wool and other animal hair (WO), silk (SE), and wild silk/Tussah (ST).

The fibers can be formed by various transformations of natural fibers, for example, regenerated cellulose & cellulose esters such as viscose (CV), bamboo regenerated (CBAM), modal (CMD), lyocell (CLY), acetate (CA), and tri-acetate (CTA).

Examples of proteinaceous fibers derived from plants include peanut (PEA), corn (COR), soybean (SPF), alginate (ALG), milk (CS), and polylactic Acid (PLA).

Examples of fibers formed from synthetic polymers include polyamides, such as Polyamide 4.6 (PA4.6), Polyamide 6 (PA 6), Polyamide 6.6 (PA 6.6), Polyamide 6.10 (PA 6.10), Polyamide 6.12 (PA 6.12), Polyamide 11 (PA 11), Polyamide 12 (PA 12), and Polyamide-imide (PAI). Also included are polyesters, such as polyethylene terephthalate (PET), poly cyclohexane-dimethanol terephthalate (PCT), polytrimethylene terephthalate (PTT), polybutylene Terephthalate (PBT), polyestermide (PETI), and polybeta hydroxybutyrate (PHB). Representative polymers also include polyurethanes (PU), including polyuretherthane (PUR), elasthane (EL), and elastodiene (ED). Also included are polyvinyl compounds, including polyvinyl chloride (CLF), polyvinylidene fluoride (PVDF), polyvinylidene chloride (PVDC), polyvinyl alcohol (PVA), polyvinyl acetate (PVAC), and ethlyene vinyl acetate (EVA). Polyolefinic fibers include polyethylene (PE) and polypropylene (PP). Some of these fibers are fluorinated, such as polyteteafluorethylene (PTFE), ethylene chlorotrifluorethylene (ECTFE), polychlorotrifluoroethylene (PCTFE), perfluoroalkoxy (PFA), and polyvinyl fluoride (PVF). Other synthetic fibers include meta-aramid (m-AR), para-aramid (p-AR), melamine formaldehyde (MF), polybenzimidazole (PBI), polycarbonate (PC), polyetheretherketone (PEEK), polyether-imide (PEI), polyetherketone (PEK), polyethersulfone (PES), polyethyleneaphtalate (PEN), polyimide (PI), polymethyl methacrylate (PMMA), polyoxymethylene or polyacetal (POM), polyphenylene oxide (PPO), polyphenylenesulfide (PPS), polystyrene (PS), and polysulfone (PSU).

Some fibers are inorganic in nature. Representative inorganic fibers include glass fiber (GF), silicic acid glass (GFS), carbon fiber (CF), ceramic fiber (CEF), metallic fibers (MTF), steel (STL), inox (INX), copper (CU), and basalt (CBF).

### Representative Fiber Lengths

In the world of regenerated fibers, there are typically three lengths that are considered. The longer length is best used in carded applications, medium length fibers used in both carded and air laid applications, and short fibers are more specific to air laid or wet lay processes. Fiber lengths can range from 50 microns to up to 6 inches or more for crimped or non-crimped fibers.

For both the regenerated fibers (isolated from post consumer and/or post-industrial waste), and the other fibers, suitable fiber lengths and distribution can vary from fibers as small as 250 microns to fibers up to 6 inches, based on the delivery mechanism.

An example of lengths of fibers necessary to a wet laid application would be 250 microns to 13 mm, where the fiber lengths in a dry direct lay application would vary from 0.50 median lengths up to 3 inches.

In one embodiment, the fibers are regenerated cotton fibers, with a size range between about 250 microns to about 8 mm for wet laid applications, and between about half inch and about 1.30 inches for dry direct lay or a combination of direct lay and air carding application.

For example, where a “direct lay with air card for randomization” approach is used, the range is most effective between 2 mm inch and about 1.30 inch. The ranges for the fibers depend, at least in part, on the desired application for the non-woven material.

When regenerated fibers are used in combination with other fibers, the regenerated fibers are preferably present in a concentration of between about 2 and about 98%, and the other fibers are preferably present in an a concentration of between about 1 and about 88%, based on the total weight of the fibers.

III. Process for Isolating Fibers from Post-Consumer or Post-Industrial Waste

Ideally, the process for isolating fibers from post-consumer or post-industrial waste involves using needles to separate the previously-woven strands into the threads that comprised the fabric to begin with. As this is difficult to do with the entire scrap material, it is advantageous to cut the scrap into a more manageable size (i.e., a uniform 2″ by 2″, 4″ by 4″, or other suitable size). It can also help to work from the ends of the scrap material, rather than the middle of the scrap material.

In some embodiments, the fibers are cellulosic fibers. It can be advantageous to slightly degrade the fibers, so that they are not as tightly knitted or woven. That is, by degrading a portion of the cellulose, the knots open up slightly, making it easier to unravel the knots and obtain the free threads.

Cellulose fibers can be degraded by contacting them with various enzymes, which enzymes include cellulases. One or a combination of such enzymes can be used. Cellulosic and other fibers typically have one or more post-treatments on them, which thicken the fibers. Enzymatic or chemical processes can be used to remove the post-treatments, thus thinning the fibers and loosening the knots or weaving.

Contact times and temperatures for the enzymatic or chemical processes can be determined using ordinary skill, for example, by monitoring the partially-degraded material to determine the optimum point in time where the threads are loosened enough to un-knit them, but not so much that a significant loss of material is observed. Ideally, the temperature is between 120 and 180° C., although these reactions can also occur at lower temperatures, such as room temperature.

After the threads are un-knitted, loose threads can be stored for later use. In some embodiments, it can be useful to remove any dyes from the threads, so that the threads resemble virgin material.

In order to process the threads into a non-woven material, it can be advantageous to “fluff” the threads into a lower density material, where the density is reduced relative to the original fibers, or clumps of fibers, obtained from the de-knitting process. Fluffing is generally accomplished using a mechanical combing and/or picking action, which selects smaller quantities of threads from the whole, and the combing and/or picking action breaks the threads down into lint or individual fibers.

The fibers or lint produced in the fluffing step are in random orientation, and in certain non-woven applications, it is desired to orient the fibers in a single direction. This can be accomplished, for example, using a modified carding operation. In a modified carding operation, a series of cylinders are used, where a comb is aligned with the cylinders. The fluffed fibers are passed over the cylinders, in contact with a plurality of combs, which orient the fibers. Once the fibers are oriented, they are suitable for use in preparing non-woven materials, particularly where the oriented fibers are intended to be mechanically interwoven, such as with a spun-lace process.

To isolate fibers from these materials, which are previously woven, knitted, or bonded together by a non-wovens process, it is necessary to un-weave or un-twist the threads. This can be accomplished, for example, by removing post-treatments from the threads, which thins the threads and loosens the knots or twists.

In the case of cellulosic fibers, a portion of the cellulosic fiber can be degraded, for example, using a cellulose enzyme, and such enzymes are known in the art, and sold, for example, by companies such as Iogen and Novozymes.

Once the threads are unwoven/untwisted, the fibers are obtained by combing the thread, which produces fibers that have maintained the length and the strength necessary to go back to textiles or, in this embodiment, non-wovens.

Before going into textiles or non-wovens, it can be advantageous to pass the fibers through one or more stages of “intimate blending,” so that the fiber distribution is relatively homogeneous. The terms “relatively homogeneous” or “substantially homogeneous” are used to mean that the average fiber size and density varies by 20% or less throughout the fiber. The intimate blending can also provide color uniformity, which can otherwise be difficult to attain when different batches of fibers are used to produce a single non-woven fabric.

### IV. Intimate Blending of the Various Fibers

In one embodiment, the fibers are subjected to an intimate blending process step. Intimate fiber blends are described herein as substantially homogeneous blends of fiber(s) that distribute the different lengths or different combinations of the fiber(s) evenly throughout the batch of fiber. The regenerated cotton non-woven fabric described herein is ideally prepared using intimate blending, to ensure homogeneous fiber distribution, due to the broad range of fiber lengths found in regenerated fibers. It is also ideally prepared using fiber humidification to maintain the strength of the fiber throughout the process, as well as using suction points and/or a filtration system to keep the equipment running efficiently, by removing dust particles and the like.

This intimate blending can contribute to the beneficial properties of the regenerated fiber substrate. The fiber distribution in regenerated textiles can be varied, and, accordingly, intimate blending of the resulting fibers can be performed, whether the fibers are used alone or as blends with other types of fibers, prior to entanglement or fusion. The use of other fibers is optional, and depends on the desired application of the resulting non-woven fabric.

Intimate blending involves initially humidifying or treating the fibers, which strengthens the fibers, if they are organic fibers such as cotton, cotton blends or fibers such as rayon or ramie, reduces dust particles for better product performance and, protecting the fibers from tensile elongation, and reduces neps.

The fibers can be humidified, for example, by exposing them to steam, contacting them with a hydrophilic compound such as glycerol/glycerine, a surfactant, water, and the like. Ideally, the humidified fibers have a moisture content of between 8 and 20% moisture, more ideally, between about 8 and about 12% moisture. Then, the fibers can be passed through one or more blending stages, where samples from multiple hoppers are blended together to reduce variation between the fibers in the hoppers, or where samples from a single hopper are blended to ensure consistency in the hopper or it could be blended using a traditional cotton/fiber laydown where bales are staged for blending. Multiple hoppers can be used, for example, where blends of different fibers are intended. Examples include using regenerated cotton fibers in combination with one or more virgin or regenerated plant fibers, such as wood, kenaf, and the like, or synthetic fibers, such as polyester or polyolefin fibers. However, the regenerated cotton fibers can be used by themselves, without adding other fibers.

The following is a general process for intimately blending fibers, though not every step needs to be carried out exactly as described below, so long as the resulting fiber distribution is substantially uniform.

Bales of regenerated fiber are taken and put into large storage hoppers based on each individual fiber type. If the blend is 100% of one fiber, then the hoppers deliver by weigh pan methods exactly or substantially the same percentage of fiber out of each hopper. If the percentages of each fiber are different, then the bales are put into the hoppers, and, using weigh pan technology, the fiber is delivered onto a belt with each “group” of fibers being laid on top of one another.

The “groups” of fiber are then put into a “fine opening” process, which carefully blends the fibers together and deposits them to the next stage of blending, which begins with a large storage hopper. In one embodiment, the hopper holds up to 40,000 lbs of fiber.

As the fiber passes through the air into the box, this provides another opportunity to blend the fibers, and also affords the opportunity to provide additional humidification or fiber treatments.

When the storage hopper is full or substantially full, the fibers can then be picked, for example, using a sandwich-like approach where the fibers are laid down horizontally into the blending hopper in layers then vertically picked up from the bottom to the top of the hopper, using a spiked apron and a moving floor, and put into yet another fine opener which takes the fibers delivered from the blending hopper and gently opens and fluffs the fibers before delivering the fibers to be baled for further processing, or directly into the specific application used to deliver the fibers to their entanglement or fusion process.

Carding

After the fibers are intimately mixed, a card wire can be used to open and gently align the fibers, to maintain a consistent web appearance. When the fibers are regenerated cotton fibers, or predominantly so (i.e., greater than about 50% regenerated cotton fibers, or regenerated and virgin cotton fibers), the resulting web has using the unique look and feel of cotton. The carding process can also be used in those embodiments where intimate mixing is not performed, before the non-woven web is produced.

### V. Fiber Treatments

Ideally, to ensure that the cotton fibers maintain their length and strength during the regeneration process, and to maximize regenerated cotton fiber processability, the fibers are humidified. In one embodiment, cotton fibers are delivered to the blending process with no less than 8%, but no greater than 25%, moisture content. This moisture level increases the fiber strength, and therefore preserves the fiber length.

It is also desirable to keep moisture levels in the fiber throughout the process, which can be done, for example, by adding humectants or other suitable materials (i.e., hydrophilic materials such as glycerol) to the fibers.

The moisture level throughout the process ideally does not drop below 5%, and in one embodiment, levels out to between 12 and 15% at the end of the process.

The fibers can also be subject to other fiber treatments, either before or after forming the fibers into a non-woven material. Representative fiber treatments include one or more of humidification, addition of surfactants to provide the fibers with greater hydrophilicity (for example, when the fibers are used for highly hydrophilic products, such as wipes or other substrates used in aqueous solutions or a substrate needing to be used to absorb liquids). Other representative treatments include, but are not limited to, starch, glycol/glycerin, antimicrobial treatments, silicone, fluorinated anti-stain treatments, addition of fire retardants, addition of cationic wet strength resins, and the like.

Representative wet strength resins include the cationic polyamide wet strength resins sold by Georgia Pacific® under the Amres® brand, and are typically supplied as aqueous solutions in a range of solids from 12.5% to 35%, and include Amres® 117, Amres® 12-HP, Amres® 135, Amres® 20-HP, Amres® 25-HP, Amres® 652, Amres® 653, Amres® 8855, Amres® 8860, Amres® 8870, Amres® HP-100, Amres® HS-30, Amres® MOC-3025, Amres® MOC-3066, Amres® PR-247HV, and Amres® PR-335 CU.

### VI. Processes for Laying Down Fibers

To form a non-woven sheet, which is then rolled to form a rolled good, one first orients the fibers in a desired manner, then lays the fibers down onto a conveyor belt to form a web, and then mechanically, chemically, or thermally bonds the fibers in the web.

The following are representative ways to lay down the fibers.

Direct Lay: One way to form a web is to use a direct carded web forming system to orient the fibers. In this embodiment, a web of fibers is directly laid, as it exits from the carder, onto a conveyor belt. This approach has not been successfully used with conventional regenerated cotton fibers, particularly due to the fact that they have tended to be short and thready (commonly known as “shoddy”), thus not providing consistency of length and strength that is required by direct lay web forming equipment.

However, the fiber regeneration techniques described herein provide regenerated fibers with suitable length and strength to be used with this type of equipment.

Direct Lay with Multiple Carded Webs:

In some embodiments, it can be desirable to provide a non-woven material which includes more than one web (i.e., a composite material), so as to provide additional thickness or other desired properties. The more than one web can be a plurality of the same web, or can include different webs. These webs can be overlaid and then delivered to a station where they can be mechanically entangled, or chemically/thermally fused.

Multiple non-woven cards can be used to create a composite product, using each carding group to deliver a specific fiber to the entanglement/fusing stations. The webs can be fused using any of a variety of methods, including spunlace, needlepunch, thermal bond or adhesive bond processes, along with other processes used to bond non-wovens in the normal art of non-woven manufacturing. This embodiment can be important where one wishes to form a composite arrangement of the regenerated fibers in the web.

In one aspect of this embodiment, a web of regenerated cotton fibers are delivered by one carding group, and a second carding group delivers a web of fibers that include encapsulated oils, fragrances, lotions or antimicrobial solutions placed on a second substrate made from regenerated cotton or cotton blends, polyester or other synthetic fibers, or a viscose web, with a third group delivering a “closing” web made of a regenerated cotton. In this manner, one can create a sandwich-like substrate, carrying a specifically-purposed composite material that can be used to form the end-use consumer product. The final product, while being relatively complex, is made with consumer-preferred regenerated fibers that are cost effective and sustainable to the business and the environment. Thus, one can provide a better product for the consumer, at a competitive price, that is sustainable to businesses and to the planet.

Direct Lay with Fiber Randomization:

In some embodiments, it can be desirable to use oriented fibers for their appearance, but also to use randomly oriented fibers for their strength. For example, a composite material can be prepared by using a direct lay process to lay down an initial web of oriented fibers, formed from either 100% regenerated cotton fibers, or a fiber blend that includes these fibers, and follow that with an air-laid or air-carded layer of randomly oriented fibers. Particularly where this air-laid or air-carded layer includes relatively long synthetic fibers (i.e., relative to the length of the cotton fibers), this layer of randomly oriented fibers can provide strength. A top web, for example, a second web including regenerated cotton fibers, can optionally be provided on top of the randomly oriented fiber web.

The present inventors have found that, by using this approach, one can provide a regenerated cotton product with the MD/CD strengths that are gained from much longer synthetic fibers. By using one or more carding groups based on weight calculation of the desired product, one can add an air carded web that is a total randomization of fibers, creating MD/CD ratios of the most sought after 1-1 strength requirements.

By adding an air carded web in the center of three carding groups, the aesthetics are that of a complete carded web product, with the strength of synthetic fibers (particularly when the air carded web includes randomly oriented synthetic fibers), while still using the more desired sustainable cotton fibers (for example, in the direct laid top and bottom webs).

Direct Lay with Cross-Lapped Web:

In some embodiments, one can obtain strength by cross-lapping webs of oriented fibers, such that the fibers in each web are oriented in a different direction than the fibers in the underlying and/or overlying webs.

This provides yet another process for using regenerated cotton fibers and still maintaining the strength of a synthetic fiber web process. In this process, a carded web is layered on a conveyor moving at right angles so that the fibers are oriented in the cross direction increasing the cross directional strength of the fabric and the web weight. The orientation of the fibers is dependent of the speed of the web delivery and the speed of the conveyor belt.

The resulting product tends to be loftier than those produced using a direct-carded web, or even the above-described embodiment where a direct lay approach is used with an air card layer to a layer with provide randomized fiber orientation.

Direct Lay with Scrim

In another embodiment, a composite material is prepared from regenerated or virgin fibers, where a scrim layer is added to the direct laid layer. This provides yet another way to increase MD/CD strength of a regenerated cotton web, where the added strength comes from the added scrim. The scrim, which in one embodiment is made of virgin or regenerated fibers, is entered in line with either a direct lay or air lay web forming process.

In this embodiment, one can produce a re-useable or washable product from the regenerated cotton fibers. The fibers can be bonded using any of a number of approaches, including spunlace and needlepunch bonding applications, to create the final product.

Air Carding/Air Laying

As used herein, “air laying” refers to dropping fibers in a random orientation onto a moving conveyer belt. The conveyor belt may have a first web fiber layer, onto which the air carded fibers are dropped.

Wet-Laying

As used herein, “wet laying” refers to a process, similar to paper making, wherein a non-woven web is produced by filtering an aqueous suspension of fibers onto a screen conveyor belt or perforated drum. The wet-laid non-wovens described herein are made with the regenerated fibers described herein, alone or in combination with wood pulp or other natural fibers, synthetic organic fibers, or inorganic fibers such as fiberglass or metal fibers.

In one embodiment, the wet laid material has more than 50%, by mass, of its fiber content made up of fibers with a length to diameter ratio greater than 300, or with more than 30%, by mass of its fibrous content, or where the density of the resulting fabric is less than 0.4 g/cc. A wet-laid web is defined as a web of fibers produced by the wet laying process, which can then be bonded by one or more techniques to provide fabric integrity.

In any of these embodiments, once the fibers are assembled, they can be mechanically, chemically, or thermally bonded as described above.

Fiber lengths can range from 250 microns to 6 inches for crimped fibers.

As used herein, “regenerated fibers” are inherently different than that of recycled fibers in the regeneration process, in that the fibers are not “damaged” to the point of losing their length or tensile strength, and have not created “clumps” or balls of fiber that are not individually separated. These features allow the user to gain the maximum benefit from these fibers when forming a non-woven material.

Wet Lay processes have proven very successful when using engineered or cut cotton or other fibers that range in length from 1 mm to 7 mm, and can be used to create cotton rich wet laid products.

Wet forming is described as a non-woven in this embodiment as use of regenerated cotton fibers, alone or in combination with other fibers, that make up more than 50% by mass of its fiberous content (excluding chemically digested vegetable fibers) with a length to diameter ratio greater than 300 or more than 30% by mass of its fiberous content is made of fibers in “a above and meet one or both of the following criteria: length or diameter ratio of more than 600, the density of the fabric is less than 0.4 g/cc. Wet laid non-wovens are produced in a process similar to paper making.

The non-woven web is produced by filtering an aqueous suspension of fiber onto a screen conveyor belt or a perforated drum. While having the characteristics of a paper like product, the strength can be increased and softness provided by a combination of latices having a lower glass transition temperature (TGC) to create a more drapeable hand or higher TGC to create strength.

### VII. Converting Fiber Webs to Non-Woven Fabric

A non-woven fabric is made directly from a web of fiber, without the yarn preparation necessary for weaving and knitting. In a non-woven, the assembly of textile fibers (i.e., the web) is held together:

1) By mechanical bonding, which involves interlocking the fibers into a random web, mat, or sheet;

2) By thermal bonding, which involves fusing the fibers, for example, by adding between 2 and 20% of a thermoplastic fiber, for example, a polyolefin (such as polypropylene) fiber. When heated, such as between calender rolls, one can fuse the fibers together;

3) By chemical bonding, which involves adding a cementing medium to the fibers, and chemically fusing the fibers together. Representative cementing media include starch, casein, rubber latex, cellulose derivatives, and synthetic resins.

4) A hybrid chemical/mechanical approach that is occasionally used with cotton non-wovens is to treat the web with sodium hydroxide, to “shrink-bond” the web. The caustic causes the cellulose-based fibers to curl and shrink around one another as the bonding technique. This approach can be advantageously used with regenerated cotton fiber.

As discussed above, the fibers may be oriented in one direction or may be deposited in a random manner to form a web or sheet, using the various processes for laying down the fibers. This web or sheet can then be bonded together by one of the methods described above. The present invention is intended to encompass non-wovens prepared using random and/or oriented fibers, laid down with any of the above-mentioned techniques, and bonded using any of the above-mentioned techniques, in any combination.

Representative bonding methods include thermal bonding, using a large oven for curing, calendering through heated rollers (called spunbond when combined with spunlaid), wherein the calenders can be smooth faced for an overall bond or patterned for a softer, more tear resistant bond, hydro-entanglement (the mechanical intertwining of fibers by water jets, called “spunlace,” ultrasonic pattern bonding, often used in high-loft or fabric insulation/quilts/bedding, needlefelt (mechanical intertwining of fibers by needles, and chemical bonding (a wetlaid process involving the use of binders, such as latex emulsion or solution polymers, to chemically join the fibers). A more expensive route uses binder fibers or powders that soften and melt to hold other non-melting fibers together. Some of the non-woven fabrication methods that can be used to prepare the non-woven materials described herein are described in more detail below.

Adhesive Bonded Fabrics

Adhesive or Chemical bonded fabrics are defined as fibrous webs formed via non-woven card, air card, or other means of distributing fibers that form a uniform or randomized group of fibers delivered by a mechanical process that are saturated with chemical binders to form a semi-durable fabric. Webs are commonly bound using chemical agents, which include adhesive resins and solvents. Most common is resin bonding. Latex resins (one form of adhesive) can be applied to the web by a variety of methods: dipping the web into the latex and removing the excess, spraying, foaming or printing bonding. The resin is usually in a water-based solution, so this bonding process typically requires heat to remove the water, and to dry and set the binder into the fabric. This is sometimes referred to as “latex bonding.”

Another context of non-woven chemical web bonding, gravure bonding is also a form of resin-based method of bonding a web of fibers using the gravure method of printing. The gravure system uses a solid roller that is engraved with numerous small indentations. In the bonding process, the roller is partially immersed into an adhesive resin solution. As the roller turns, the excess solution is removed by a doctor blade, which leaves only the adhesive binder solution in the roller's indentations. An unbonded web is then squeezed against the gravure roller (generally by a rubber roller) and the resin penetrates the web by osmosis. The web is then dried to remove the water and the binder remains.

Foam Bonding Fabrics

This is a method for applying a resin to a loose web to bind the fibers. The resin is turned into a foam which then coats the fibers. An advantage of foam bonding is that little to no water is used in the binder thus requiring less heat energy and time to dry and cure the binder.

Needle-Punch Fabrics

Needle-punched non-wovens are created by mechanically orienting and interlocking the fibers of a direct air card, crosslapped, or any other mechanical dry web forming process. This mechanical interlocking is achieved with thousands of barbed felting needles repeatedly passing into and out of the web.

Spunbond/Spunbonded

This spunlaid technology is a process of bonding the delivered web in which the filaments have been extruded, drawn and laid on a moving screen to form a web. The term is often interchanged with “spunlaid,” but the industry had conventionally adopted the spunbond or spunbonded term to denote a specific web forming process. This language is used to differentiate this web forming process from the other two forms of the spunlaid web forming process, which are “melt-blown” and “flashspinning.”

Spunlace Fabrics

The spunlace process is a process for bonding a web by interlocking and entangling the fibers about each other with high velocity streams of water (synonymous with Hydroentangling). The web or fabric may have other bonding methods in addition to spunlacing. Spunlacing, not to be confused with spunlaid, is generally produced from a web made up of staple fibers from a dry formed, carded system, but small quantities of spunlace bonding are done on production lines that use a wet laid forming process. A recent technical development is the production of a spunlaced non-woven from a spunlaid, continuous filament web.

Spunlaced fabrics show high drape, softness and comfortable handle because more fiber entanglement leads to increased strength without an increase in shear modulus. There is typically a relationship between the absorbency capacity of the spunlaced product and the amount of hydroentangling energy used. The softness of the fabric is explained by the fact that the entangled structures are more compressible than bonded ones, as well as having mobility and partial alignment of fibers in the thickness direction.

Stitch Bond, Stitch Bonded

This is a technique in which fibers in a web are bonded together by stitches sewn or knitted through the web to form a fabric. The finished fabric usually resembles corduroy. Ideally, medium to long regenerated fibers are used in this application.

Thermal Bonded Fabrics

Thermal bonded or thermobonding fabrics is defined by INDA as the use of a technique for bonding a web of fibers in which a heat or ultrasonic weld is used to activate a heat-sensitive material. The material may be in the form of homofil fibers, bi-component fibers or fusible powders, as part of the web. The bonding can be applied all over (e.g. through or area bonding) or restricted to specific, discreet sites (e.g. point bonding).

Through-Air Bonding

This is a bonding system that that uses high temperature air to fuse the web's fibers. There are two basic systems: blowing hot air through the web in a conveyor oven or passing heated air through the web on a rotating drum (illustrated below). Fabrics made from bi-component fibers or blends of bi-component and regular fiber are often bonded by through-air bonding systems. This method is sometimes referred to as air-through bonding.

In any of the above-mentioned techniques, the resulting bonded web or mat is then either used directly to form finished goods, or can be rolled-up and stored for later conversion to finished goods.

VIII. Materials Formed from the Non-Woven Fabric

The non-woven materials produced using the methods described herein can be used in numerous applications, including hygiene products, medical products, filters, geotextiles, and other products. Representative hygiene products include baby diapers, feminine hygiene products, adult incontinence products, wipes, including anti-septic wipes, bandages and wound dressings. Representative medical products include isolation gowns, surgical gowns, surgical drapes and covers, surgical scrub suits, and caps. Representative filters include gasoline, oil and air filters, including HEPA filtration, water, coffee, and tea bags, liquid cartridges and bag filters, vacuum bags, allergen membranes, and laminates with non woven layers. Representative geotextiles include soil stabilizers and roadway underlayment, foundation stabilizers, erosion control, canals construction, drainage systems, geomeambranes protection, frost protection, agriculture mulch, pond and canal water barriers, and sand infiltration barriers for drainage tile. Other products include both primary and secondary carpet backing, composites, marine sail laminates, tablecover laminates, chopped strand mats, backing/stabilizer for machine embroidery, packaging—to sterilize medical products, insulation (fiberglass batting), pillows, cushions, and upholstery padding, batting in quilts or comforters, consumer and medical face masks, mailing envelopes, tarps, tenting and transportation (lumber, steel) wrapping, and disposable clothing (foot coverings, coveralls).

The production of the various materials described above from a non-woven fabric can be done using methods well known to those of skill in the art.

The present invention will be better understood with reference to the following non-limiting examples.

### Example 1

### Process for Creating Regenerated Cotton Spunlace Wipes

The following process was used to create regenerated cotton spunlace wipes, and covers the process from raw material to finished roll goods:
1. +/−16,500 lbs sorted cotton clips were gathered and collected at textile cutting room locations, packaged and shipped to regenerator location.
2. After complete inspection and receipt to regeneration facility's warehouse, the cotton clippings were placed into a robot loader for automatic bale opening and conveyed to specialty cutters.
3. They were cut to targeted size of 2-4 in×2-4 in. These cut pieces were transported by belt to the storage box where the first blending of materials began.
4. The cut clips were transported via spike apron to a rotary pin cylinder where they are pulled to untwist the fibers into threads that comprised the fabric.
5. They were transported via air duct to another large storage box where it was treated with a solution of a 2-6% cellulase enzyme, surfactant, and/or a blend of enzymes and surfactants. This solution removes any finishes, starches, etc from the fiber. These fibers were treated for 12 hours for this process.
6. The treated pre-opened material is then transported by air duct to a second box where it was passed through steam to disinfect and deactivate the enzymatic treatment.
7. The material was then processed through a series of 5 modified cylindrical process pieces of equipment to continue further opening of the material to a soft thread state. There was an additional passing through steam after cylinder 2 and 4 to allow the moisture levels to be maintained and the fibers were further untwisted from their original state.
8. The soft threads were then put into a bale and moved to an intimate blending area.
9. The fiber was intimately blended using a laydown process with the baled opened cotton fibers to create a homogeneous fiber blend. The staging of the bales and the even distribution of collecting fibers created the desired degree of fiber blending.
10. The blended fiber was transported via air duct to the finishing line system that further untwisted the remaining soft threads, while perfectly aligning the fibers and pulling out all dust and shorter fibers to a secondary process.
11. Once processed through the regeneration fiber finishing stage, the fibers were carried via air duct to the non-woven blend area. Here the regenerated cotton fiber was further blended together to ensure the lengths of fibers were consistent throughout the batch using pre-feed hoppers, fine openers and blending bins.
12. The regenerated cotton was then transported through a series of non-woven cards including a randomization card for an additional strengthening web to create the layered web section necessary.
13. After the desired web layers were formed, they were transported via conveyor to a pre-entangler to wet the web.
14. The wet mat of fibers was then moved through two drums containing at least two jet strip sections per drum.
15. The material was then conveyed over a series of vacuums on the flatbed section and onto a series of dryer drums to be dried.
16. Once dried, the material was calendared with multiple heated rollers with and without patterns. The heated rollers smoothed and embossed the substrate.
17. The material was then sent to the winder as a non-woven fabric, which fabric had suitable strength for use as a non-woven wipe.

The resulting input and outputs were:

16,500+/−lbs of cotton clips collected

15,000+/−lbs of opened fiber

12,300+/−lbs of finished fiber

96,000+/−meters of 55 gsm substrate produced

The substrate produced results within these ranges:

| | | WORK | | | | TEST | |
|---|---|---|---|---|---|---|---|
| PROPERTY | UNITS | INSTRUCTION | TARGET | MIN | MAX | PR | TEST DN |
| BASIS WEIGHT | GSM | QUAL.WI.10.001.R | PR 56.6 | *51.0 | *61.0 | E | E |
| | | | DN 56.0 | *51.0 | *61.0 | | |
| CALIPER | MM | QUAL.WI.10.048.R | PR .67 | TBD | TBD | E | |
| | | | DN .65 | *0.55 | *0.75 | | S1 |
| CDWT/ | G/in/% | QUAL.WI.10.080.R | 1100 | *600 | *2200 | | E |
| STRETCH | | | | | | | |
| CDDT/ | G/in/% | QUAL.WI.10.006.R | 850 | *450 | *1700 | E | C |
| STRETCH | | | | | | | |
| MDWT/ | G/in/% | QUAL.WI.10.080.R | 3500 | *2000 | *6500 | | E |
| STRETCH | | | | | | | |
| MDDT/ | G/in/% | QUAL.WI.10.006.R | 2400 | *1500 | *4800 | E | C |
| STRETCH | | | | | | | |
| Absorbency | Sec | QUAL.WI.10.053.R | TBD | TBD | TBD | C | C |
| Capacity | % | QUAL.WI.10.053.R | 1115 | *800 | | C | C |
| Web Appearance | Visual | QUAL.WI.10.003.R | 1.0 | *0.5 | *3 | E | |
| Visual | Per m² | QUAL.WI.10.056.R | | | | S2/S# | |
| Defects/VFM | Per Ship | | 0 | | *.067 | | |
| Holes | AVG | | 0 | | *.5 | | |
| Foreign Matter- | AVG | | 0 | | *0.75 | | |
| 2 Consecutive | | | | | | | |
| inspects | | | | | | | |
| BIO-Non- | CFU/g | QUAL.WI.10.083.R | | | | | S3 |
| Pathogenic | | | | | | | |
| Bacterial | | | 0 | | 100 | | |
| Mold/Yeast | | | 0 | | 30 | | |
| HUNTER | L | QUAL.WI.10.049.R | 96.6 | | | E | |
| COLOR | A | | 1.8 | | | E | |
| | B | | −8.7 | | | E | |

Accordingly, the process described herein can be used to prepare a non-woven roll good, which can be used to prepare a variety of finished products.

While the invention has been described in connection with the preferred embodiments and examples, it will be understood that modifications within the principles outlined above will be evident to those skilled in the art. Thus, the invention is not limited to the preferred embodiments and examples, but is intended to encompass such modifications.

1. A process for preparing a fiber roll good from regenerated fibers, comprising the steps of:
a) obtaining a source of regenerated cotton fibers with an average fiber length between about 0.25 and about 1.5 inches,
b) using direct lay carding to orient the fibers and form a fiber web,
c) using spun-lace bonding to bond the fibers in the web and form a non-woven material, and
d) rolling the resulting material to form a non-woven fiber roll good.

2. The process of claim 1, further comprising hydro-embossing the fiber roll good.

3. The process of claim 1, further comprising forming the non-woven fiber roll good into a size suitable for use as a wipe.

4. The process of claim 3, wherein the wipe comprises one or more of moisturizers, cleansers, essential oils, antibacterials, antivirals, antimicrobial cationic polymers, and the like.

5. The process of claim 1, further comprising applying a post-treatment to the non-woven fiber roll, wherein the post-treatment is selected from the group consisting of starch, glycol/glycerin, antimicrobial treatments, silicone, fluorinated anti-stain treatments, fire retardants, and cationic wet strength resins.

6. The process of claim 1, wherein the non-woven fiber roll good comprises a further layer, wherein the further layer is applied over the direct lay carded web before the fibers in the web are bonded together.

7. The process of claim 5, wherein the further layer is applied by a process selected from:
a) air carding a random fiber layer over the direct carded layer, and optionally laying an additional direct carded layer over the random fiber layer,
b) cross-laying one or more additional direct carded layers over the first directed carded layer,
c) direct laying one or more additional direct carded layers over the first carded layer, and
d) applying a scrim to the direct carded layer.

8. The process of claim 1, wherein the non-woven roll good is converted to a product selected from the group consisting of baby diapers, feminine hygiene products, adult incontinence products, wipes, bandages, wound dressings, isolation gowns, surgical gowns, surgical drapes, surgical covers, surgical scrub suits, surgical caps, gasoline filters, oil filters, air filters, water filters, coffee filters, tea bags, liquid cartridges, bag filters, vacuum bags, allergen membranes, laminates with non woven layers, soil stabilizers, roadway underlayment, foundation stabilizers, erosion control, canals construction, drainage systems, geomeambranes protection, frost protection, agriculture mulch, pond and canal water barriers, sand infiltration barriers for drainage tile, primary and secondary carpet backing, composites, marine sail laminates, tablecover laminates, chopped strand mats, backing/stabilizer for machine embroidery, packaging, insulation, pillows, cushions, upholstery padding, batting, consumer masks, medical face masks, mailing envelopes, tarps, tenting transportation wrapping, and disposable clothing.

9. The process of claim 1, wherein the regenerated fibers are prepared by a process comprising:
a) detangling the fibers,
b) removing any finish from the fibers, if present,
c) combing and/or picking the fibers to convert any threads into fibers,
d) humidifying the fibers, and
e) intimately blending the fibers,
before the fibers are carded to form the direct carded layer.

10. A process for preparing a fiber roll good from regenerated fibers, comprising the steps of:
a) obtaining a source of regenerated cotton fibers with an average fiber length between about 0.25 and about 3.5 inches,
b) forming an intimate blend of the regenerated cotton fibers and a source of other fibers, wherein such other fibers are selected from the group consisting of fibers derived from plant matter, fibers derived from animal hair, silk fibers, protein-based fibers, transformed natural fibers, wholly-synthetic (organic) fibers, glass fibers and metal fibers,
c) using direct lay carding to orient the fibers and form a fiber web,
d) using a mechanical bonding process bond the fibers in the web to form a non-woven material, and
e) rolling the resulting material to form a non-woven fiber roll good,
wherein the blend of regenerated cotton fibers and other fibers includes between about 2 and about 99% by weight of regenerated cotton fibers and between about 1 and about 88% by weight of other fibers.

11. The process of claim 10, further comprising hydro-embossing the fiber roll good.

12. The process of claim 10, wherein the other fibers are selected from the group consisting of Tencel, Rayon, Lyocel, Polyester, polypropylene (PP), nylon, and PLA fibers.

13. The process of claim 10, wherein the mechanical bonding process is selected from the group consisting of spun lace, ultrasonic pattern bonding, or needlefelt/needle punching processes.

14. The process of claim 13, further comprising forming the non-woven fiber roll good into a size suitable for use as a wipe.

15. The process of claim 14, wherein the wipe comprises one or more of moisturizers, cleansers, essential oils, antibacterials, antivirals, antimicrobial cationic polymers, and the like.

16. The process of claim 10, further comprising applying a post-treatment to the non-woven fiber roll, wherein the post-treatment is selected from the group consisting of starch, glycol/glycerin, antimicrobial treatments, silicone, fluorinated anti-stain treatments, fire retardants, and cationic wet strength resins.

17. The process of claim 10, wherein the non-woven fiber roll good comprises a further layer, wherein the further layer is applied over the direct lay carded web before the fibers in the web are bonded together.

18. The process of claim 17, wherein the further layer is applied by a process selected from:
a) air carding a random fiber layer over the direct carded layer, and optionally laying an additional direct carded layer over the random fiber layer,
b) cross-laying one or more additional direct carded layers over the first directed carded layer,
c) direct laying one or more additional direct carded layers over the first carded layer, and
d) applying a scrim to the direct carded layer.

19. The process of claim 10, wherein the other fibers are selected from the group consisting of Tencel, Rayon, Lyocel, Polyester, PP, Nylon, and PLA.

20. The process of claim 10, wherein the regenerated fibers are prepared by a process comprising:
a) detangling the fibers,
b) removing any finish from the fibers, if present,
c) combing and/or picking the fibers to convert any threads into fibers,
d) humidifying the fibers, and
e) intimately blending the fibers,
wherein the intimate blending step can be performed before and/or after the other fibers are added, and
wherein the intimate blending step occurs before the fibers are carded to form the direct carded layer.

21. The process of claim 10, wherein the non-woven roll good is converted to a product selected from the group consisting of baby diapers, feminine hygiene products, adult incontinence products, wipes, bandages, wound dressings, isolation gowns, surgical gowns, surgical drapes, surgical covers, surgical scrub suits, surgical caps, gasoline filters, oil filters, air filters, water filters, coffee filters, tea bags, liquid cartridges, bag filters, vacuum bags, allergen membranes, laminates with non woven layers, soil stabilizers, roadway underlayment, foundation stabilizers, erosion control, canals construction, drainage systems, geomeambranes protection, frost protection, agriculture mulch, pond and canal water barriers, sand infiltration barriers for drainage tile, primary and secondary carpet backing, composites, marine sail laminates, tablecover laminates, chopped strand mats, backing/stabilizer for machine embroidery, packaging, insulation, pillows, cushions, upholstery padding, batting, consumer masks, medical face masks, mailing envelopes, tarps, tenting transportation wrapping, and disposable clothing.

22. A process for preparing a fiber roll good from regenerated fibers, comprising the steps of:
a) obtaining a source of regenerated cotton fibers with an average fiber length between about 0.25 and about 1.5 inches,
b) using direct lay carding to orient the fibers and form a fiber web,
c) applying a chemical or thermal bonding agent,
d) curing the chemical bonding agent or heating the thermal bonding agent to bond the fibers in the web and form a non-woven material, and
e) rolling the resulting material to form a non-woven fiber roll good.

23. The process of claim 22, further comprising hydro-embossing the fiber roll good.

24. The process of claim 22, further comprising forming the non-woven fiber roll good into a size suitable for use as a wipe.

25. The process of claim 24, wherein the wipe comprises one or more of moisturizers, cleansers, essential oils, antibacterials, antivirals, antimicrobial cationic polymers, and the like.

26. The process of claim 22, further comprising applying a post-treatment to the non-woven fiber roll, wherein the post-treatment is selected from the group consisting of starch, glycol/glycerin, antimicrobial treatments, silicone, fluorinated anti-stain treatments, fire retardants, and cationic wet strength resins.

27. The process of claim 22, wherein the non-woven fiber roll good comprises a further layer, wherein the further layer is applied over the direct lay carded web before the fibers in the web are bonded together.

28. The process of claim 27, wherein the further layer is applied by a process selected from:
a) air carding a random fiber layer over the direct carded layer, and optionally laying an additional direct carded layer over the random fiber layer,
b) cross-laying one or more additional direct carded layers over the first directed carded layer,
c) direct laying one or more additional direct carded layers over the first carded layer, and
d) applying a scrim to the direct carded layer.

29. The process of claim 22, wherein the regenerated fibers are prepared by a process comprising:
a) detangling the fibers,
b) removing any finish from the fibers, if present,
c) combing and/or picking the fibers to convert any threads into fibers,
d) humidifying the fibers, and
e) intimately blending the fibers,
before the fibers are carded to form the direct carded layer.

30. The process of claim 22, wherein the non-woven roll good is converted to a product selected from the group consisting of baby diapers, feminine hygiene products, adult incontinence products, wipes, bandages, wound dressings, isolation gowns, surgical gowns, surgical drapes, surgical covers, surgical scrub suits, surgical caps, gasoline filters, oil filters, air filters, water filters, coffee filters, tea bags, liquid cartridges, bag filters, vacuum bags, allergen membranes, laminates with non woven layers, soil stabilizers, roadway underlayment, foundation stabilizers, erosion control, canals construction, drainage systems, geomeambranes protection, frost protection, agriculture mulch, pond and canal water barriers, sand infiltration barriers for drainage tile, primary and secondary carpet backing, composites, marine sail laminates, tablecover laminates, chopped strand mats, backing/stabilizer for machine embroidery, packaging, insulation, pillows, cushions, upholstery padding, batting, consumer masks, medical face masks, mailing envelopes, tarps, tenting transportation wrapping, and disposable clothing.

31. A process for preparing a fiber roll good from regenerated fibers, comprising the steps of:
a) obtaining a source of regenerated cotton fibers with an average fiber length between about 0.25 and about 3.5 inches,
b) forming an intimate blend of the regenerated cotton fibers and a source of other fibers, wherein such other fibers are selected from the group consisting of fibers derived from plant matter, fibers derived from animal hair, silk fibers, protein-based fibers, transformed natural fibers, wholly-synthetic (organic) fibers, glass fibers and metal fibers,
c) using direct lay carding to orient the fibers and form a fiber web,
d) applying a chemical bonding agent or a thermal bonding agent to the fibers,
e) curing the chemical bonding agent or heating the thermal bonding agent to bond the fibers in the web to form a non-woven material, and
f) rolling the resulting material to form a non-woven fiber roll good,
wherein the blend of regenerated cotton fibers and other fibers includes between about 2 and about 99% by weight of regenerated cotton fibers and between about 1 and about 88% by weight of other fibers.

32. The process of claim 31, further comprising hydro-embossing the fiber roll good.

33. The process of claim 31, wherein the other fibers are selected from the group consisting of Tencel, Rayon, Lyocel, Polyester, polypropylene (PP), nylon, and PLA fibers.

34. The process of claim 31, wherein the chemical bonding agent is selected from the group consisting of starch, casein, rubber, latex, a cellulose derivative, and synthetic resins.

35. The process of claim 31, further comprising forming the non-woven fiber roll good into a size suitable for use as a wipe.

36. The process of claim 35, wherein the wipes comprise one or more of moisturizers, cleansers, essential oils, antibacterials, antivirals, and antimicrobial cationic polymers.

37. The process of claim 31, further comprising applying a post-treatment to the non-woven fiber roll, wherein the post-treatment is selected from the group consisting of starch, glycol/glycerin, antimicrobial treatments, silicone, fluorinated anti-stain treatments, fire retardants, and cationic wet strength resins.

38. The process of claim 31, wherein the non-woven fiber roll good comprises a further layer, wherein the further layer is applied over the direct lay carded web before the fibers in the web are bonded together.

39. The process of claim 38, wherein the further layer is applied by a process selected from:
a) air carding a random fiber layer over the direct carded layer, and optionally laying an additional direct carded layer over the random fiber layer,
b) cross-laying one or more additional direct carded layers over the first directed carded layer,
c) direct laying one or more additional direct carded layers over the first carded layer, and
d) applying a scrim to the direct carded layer.

40. The process of claim 31, wherein the other fibers are selected from the group consisting of Tencel, Rayon, Lyocel, Polyester, PP, Nylon, and PLA.

41. The process of claim 31, wherein the regenerated fibers are prepared by a process comprising:
a) detangling the fibers,
b) removing any finish from the fibers, if present,
c) combing and/or picking the fibers to convert any threads into fibers,
d) humidifying the fibers, and
e) intimately blending the fibers,
wherein the intimate blending step can be performed before and/or after the other fibers are added, and
wherein the intimate blending step occurs before the fibers are carded to form the direct carded layer.

42. The process of claim 31, wherein the non-woven roll good is converted to a product selected from the group consisting of baby diapers, feminine hygiene products, adult incontinence products, wipes, bandages, wound dressings, isolation gowns, surgical gowns, surgical drapes, surgical covers, surgical scrub suits, surgical caps, gasoline filters, oil filters, air filters, water filters, coffee filters, tea bags, liquid cartridges, bag filters, vacuum bags, allergen membranes, laminates with non woven layers, soil stabilizers, roadway underlayment, foundation stabilizers, erosion control, canals construction, drainage systems, geomeambranes protection, frost protection, agriculture mulch, pond and canal water barriers, sand infiltration barriers for drainage tile, primary and secondary carpet backing, composites, marine sail laminates, tablecover laminates, chopped strand mats, backing/stabilizer for machine embroidery, packaging, insulation, pillows, cushions, upholstery padding, batting, consumer masks, medical face masks, mailing envelopes, tarps, tenting transportation wrapping, and disposable clothing.

43. A process for preparing a fiber roll good from regenerated fibers, comprising the steps of:
a) obtaining a source of regenerated cotton fibers with an average fiber length between about 0.25 and about 1.5 inches,
b) air carding the fibers to form a fiber web,
c) using spun-lace bonding to bond the fibers in the web and form a non-woven material, and
d) rolling the resulting material to form a non-woven fiber roll good.

44. The process of claim 43, further comprising hydro-embossing the fiber roll good.

45. The process of claim 43, further comprising forming the non-woven fiber roll good into a size suitable for use as a wipe.

46. The process of claim 45, wherein the wipe comprises one or more of moisturizers, cleansers, essential oils, antibacterials, antivirals, antimicrobial cationic polymers, and the like.

47. The process of claim 43, further comprising applying a post-treatment to the non-woven fiber roll, wherein the post-treatment is selected from the group consisting of starch, glycol/glycerin, antimicrobial treatments, silicone, fluorinated anti-stain treatments, fire retardants, and cationic wet strength resins.

48. The process of claim 43, wherein the non-woven fiber roll good comprises a further layer, wherein the further layer is applied over the air carded web before the fibers in the web are bonded together.

49. The process of claim 48, wherein the further layer is applied by a process selected from:
a) air carding a random fiber layer over the first carded layer, and optionally laying an additional direct carded layer over the random fiber layer,
b) cross-laying one or more additional direct carded layers over the first air carded layer,
c) direct laying one or more additional direct carded layers over the first air carded layer, and
d) applying a scrim to the air carded layer.

50. The process of claim 43, wherein the non-woven roll good is converted to a product selected from the group consisting of baby diapers, feminine hygiene products, adult incontinence products, wipes, bandages, wound dressings, isolation gowns, surgical gowns, surgical drapes, surgical covers, surgical scrub suits, surgical caps, gasoline filters, oil filters, air filters, water filters, coffee filters, tea bags, liquid cartridges, bag filters, vacuum bags, allergen membranes, laminates with non woven layers, soil stabilizers, roadway underlayment, foundation stabilizers, erosion control, canals construction, drainage systems, geomeambranes protection, frost protection, agriculture mulch, pond and canal water barriers, sand infiltration barriers for drainage tile, primary and secondary carpet backing, composites, marine sail laminates, tablecover laminates, chopped strand mats, backing/stabilizer for machine embroidery, packaging, insulation, pillows, cushions, upholstery padding, batting, consumer masks, medical face masks, mailing envelopes, tarps, tenting transportation wrapping, and disposable clothing.

51. The process of claim 43, wherein the regenerated fibers are prepared by a process comprising:
a) detangling the fibers,
b) removing any finish from the fibers, if present,
c) combing and/or picking the fibers to convert any threads into fibers,
d) humidifying the fibers, and
e) intimately blending the fibers.

52. A process for preparing a fiber roll good from regenerated fibers, comprising the steps of:
a) obtaining a source of regenerated cotton fibers with an average fiber length between about 0.25 and about 3.5 inches,
b) forming an intimate blend of the regenerated cotton fibers and a source of other fibers, wherein such other fibers are selected from the group consisting of fibers derived from plant matter, fibers derived from animal hair, silk fibers, protein-based fibers, transformed natural fibers, wholly-synthetic (organic) fibers, glass fibers and metal fibers,
c) air carding the fibers and form a fiber web,
d) using a mechanical bonding process bond the fibers in the web to form a non-woven material, and
e) rolling the resulting material to form a non-woven fiber roll good,
wherein the blend of regenerated cotton fibers and other fibers includes between about 2 and about 99% by weight of regenerated cotton fibers and between about 1 and about 88% by weight of other fibers.

53. The process of claim 52, further comprising hydro-embossing the fiber roll good.

54. The process of claim 52, wherein the other fibers are selected from the group consisting of Tencel, Rayon, Lyocel, Polyester, polypropylene (PP), nylon, and PLA fibers.

55. The process of claim 52, wherein the mechanical bonding process is selected from the group consisting of spun lace, ultrasonic pattern bonding, or needlefelt/needle punching processes.

56. The process of claim 52, further comprising forming the non-woven fiber roll good into a size suitable for use as a wipe.

57. The process of claim 56, wherein the wipe comprises one or more of moisturizers, cleansers, essential oils, antibacterials, antivirals, antimicrobial cationic polymers, and the like.

58. The process of claim 52, further comprising applying a post-treatment to the non-woven fiber roll, wherein the post-treatment is selected from the group consisting of starch, glycol/glycerin, antimicrobial treatments, silicone, fluorinated anti-stain treatments, fire retardants, and cationic wet strength resins.

59. The process of claim 52, wherein the non-woven fiber roll good comprises a further layer, wherein the further layer is applied over the air carded web before the fibers in the web are bonded together.

60. The process of claim 59, wherein the further layer is applied by a process selected from:
a) air carding a random fiber layer over the first carded layer, and optionally laying an additional direct carded layer over the random fiber layer,
b) cross-laying one or more additional direct carded layers over the first air carded
layer,
c) direct laying one or more additional direct carded layers over the first air carded layer, and
d) applying a scrim to the air carded layer.

61. The process of claim 52, wherein the other fibers are selected from the group consisting of Tencel, Rayon, Lyocel, Polyester, PP, Nylon, and PLA.

62. The process of claim 52, wherein the regenerated fibers are prepared by a process comprising:
a) detangling the fibers,
b) removing any finish from the fibers, if present,
c) combing and/or picking the fibers to convert any threads into fibers,
d) humidifying the fibers, and
e) intimately blending the fibers,
wherein the intimate blending step can be performed before and/or after the other fibers are added.

63. The process of claim 52, wherein the non-woven roll good is converted to a product selected from the group consisting of baby diapers, feminine hygiene products, adult incontinence products, wipes, bandages, wound dressings, isolation gowns, surgical gowns, surgical drapes, surgical covers, surgical scrub suits, surgical caps, gasoline filters, oil filters, air filters, water filters, coffee filters, tea bags, liquid cartridges, bag filters, vacuum bags, allergen membranes, laminates with non woven layers, soil stabilizers, roadway underlayment, foundation stabilizers, erosion control, canals construction, drainage systems, geomeambranes protection, frost protection, agriculture mulch, pond and canal water barriers, sand infiltration barriers for drainage tile, primary and secondary carpet backing, composites, marine sail laminates, tablecover laminates, chopped strand mats, backing/stabilizer for machine embroidery, packaging, insulation, pillows, cushions, upholstery padding, batting, consumer masks, medical face masks, mailing envelopes, tarps, tenting transportation wrapping, and disposable clothing.

64. A process for preparing a fiber roll good from regenerated fibers, comprising the steps of:
a) obtaining a source of regenerated cotton fibers with an average fiber length between about 0.25 and about 1.5 inches,
b) air carding the fibers to form a fiber web,
c) applying a chemical or thermal bonding agent,
d) curing the chemical bonding agent or heating the thermal bonding agent to bond the fibers in the web and form a non-woven material, and
e) rolling the resulting material to form a non-woven fiber roll good.

65. The process of claim 64, further comprising hydro-embossing the fiber roll good.

66. The process of claim 65, further comprising forming the non-woven fiber roll good into a size suitable for use as a wipe.

67. The process of claim 66, wherein the wipe comprises one or more of moisturizers, cleansers, essential oils, antibacterials, antivirals, antimicrobial cationic polymers, and the like.

68. The process of claim 65, further comprising applying a post-treatment to the non-woven fiber roll, wherein the post-treatment is selected from the group consisting of starch, glycol/glycerin, antimicrobial treatments, silicone, fluorinated anti-stain treatments, fire retardants, and cationic wet strength resins.

69. The process of claim 65, wherein the non-woven fiber roll good comprises a further layer, wherein the further layer is applied over the air carded web before the fibers in the web are bonded together.

70. The process of claim 69, wherein the further layer is applied by a process selected from:
a) air carding a random fiber layer over the first carded layer, and optionally laying an additional direct carded layer over the random fiber layer,
b) cross-laying one or more additional direct carded layers over the first air carded layer,
c) direct laying one or more additional direct carded layers over the first air carded layer, and
d) applying a scrim to the air carded layer.

71. The process of claim 65, wherein the regenerated fibers are prepared by a process comprising:
a) detangling the fibers,
b) removing any finish from the fibers, if present,
c) combing and/or picking the fibers to convert any threads into fibers,
d) humidifying the fibers, and
e) intimately blending the fibers.

72. The process of claim 65, wherein the non-woven roll good is converted to a product selected from the group consisting of baby diapers, feminine hygiene products, adult incontinence products, wipes, bandages, wound dressings, isolation gowns, surgical gowns, surgical drapes, surgical covers, surgical scrub suits, surgical caps, gasoline filters, oil filters, air filters, water filters, coffee filters, tea bags, liquid cartridges, bag filters, vacuum bags, allergen membranes, laminates with non woven layers, soil stabilizers, roadway underlayment, foundation stabilizers, erosion control, canals construction, drainage systems, geomeambranes protection, frost protection, agriculture mulch, pond and canal water barriers, sand infiltration barriers for drainage tile, primary and secondary carpet backing, composites, marine sail laminates, tablecover laminates, chopped strand mats, backing/stabilizer for machine embroidery, packaging, insulation, pillows, cushions, upholstery padding, batting, consumer masks, medical face masks, mailing envelopes, tarps, tenting transportation wrapping, and disposable clothing.

73. A process for preparing a fiber roll good from regenerated fibers, comprising the steps of:
a) obtaining a source of regenerated cotton fibers with an average fiber length between about 0.25 and about 3.5 inches,
b) forming an intimate blend of the regenerated cotton fibers and a source of other fibers, wherein such other fibers are selected from the group consisting of fibers derived from plant matter, fibers derived from animal hair, silk fibers, protein-based fibers, transformed natural fibers, wholly-synthetic (organic) fibers, glass fibers and metal fibers,
c) air carding the fibers and form a fiber web,
d) applying a chemical bonding agent or a thermal bonding agent to the fibers,
e) curing the chemical bonding agent or heating the thermal bonding agent to bond the fibers in the web to form a non-woven material, and
f) rolling the resulting material to form a non-woven fiber roll good,
wherein the blend of regenerated cotton fibers and other fibers includes between about 2 and about 99% by weight of regenerated cotton fibers and between about 1 and about 88% by weight of other fibers.

74. The process of claim 73, further comprising hydro-embossing the fiber roll good.

75. The process of claim 73, wherein the other fibers are selected from the group consisting of Tencel, Rayon, Lyocel, Polyester, polypropylene (PP), nylon, and PLA fibers.

76. The process of claim 73, wherein the chemical bonding agent is selected from the group consisting of starch, casein, rubber, latex, a cellulose derivative, and synthetic resins.

77. The process of claim 73, further comprising forming the non-woven fiber roll good into a size suitable for use as a wipe.

78. The process of claim 77, wherein the wipes comprise one or more of moisturizers, cleansers, essential oils, antibacterials, antivirals, and antimicrobial cationic polymers.

79. The process of claim 73, further comprising applying a post-treatment to the non-woven fiber roll, wherein the post-treatment is selected from the group consisting of starch, glycol/glycerin, antimicrobial treatments, silicone, fluorinated anti-stain treatments, fire retardants, and cationic wet strength resins.

80. The process of claim 73, wherein the non-woven fiber roll good comprises a further layer, wherein the further layer is applied over the air carded web before the fibers in the web are bonded together.

81. The process of claim 80, wherein the further layer is applied by a process selected from:
a) air carding a random fiber layer over the first carded layer, and optionally laying an additional direct carded layer over the random fiber layer,
b) cross-laying one or more additional direct carded layers over the first air carded layer,
c) direct laying one or more additional direct carded layers over the first air carded layer, and
d) applying a scrim to the air carded layer.

82. The process of claim 73, wherein the other fibers are selected from the group consisting of Tencel, Rayon, Lyocel, Polyester, PP, Nylon, and PLA.

83. The process of claim 73, wherein the regenerated fibers are prepared by a process comprising:
a) detangling the fibers,
b) removing any finish from the fibers, if present,
c) combing and/or picking the fibers to convert any threads into fibers,
d) humidifying the fibers, and
e) intimately blending the fibers,
wherein the intimate blending step can be performed before and/or after the other fibers are added.

84. The process of claim 73, wherein the non-woven roll good is converted to a product selected from the group consisting of baby diapers, feminine hygiene products, adult incontinence products, wipes, bandages, wound dressings, isolation gowns, surgical gowns, surgical drapes, surgical covers, surgical scrub suits, surgical caps, gasoline filters, oil filters, air filters, water filters, coffee filters, tea bags, liquid cartridges, bag filters, vacuum bags, allergen membranes, laminates with non woven layers, soil stabilizers, roadway underlayment, foundation stabilizers, erosion control, canals construction, drainage systems, geomeambranes protection, frost protection, agriculture mulch, pond and canal water barriers, sand infiltration barriers for drainage tile, primary and secondary carpet backing, composites, marine sail laminates, tablecover laminates, chopped strand mats, backing/stabilizer for machine embroidery, packaging, insulation, pillows, cushions, upholstery padding, batting, consumer masks, medical face masks, mailing envelopes, tarps, tenting transportation wrapping, and disposable clothing.
